(19) United States
(12) Patent Application Publication
(10) Pub. No.: US 2005/0132298 A1
(43) Pub. Date: Jun. 16, 2005

(54) Displaying interactive chat sessions

(76) Inventors: Hermann Lueckhoff, Sunnyvale, CA (US); Janaki Kumar, Palo Alto, CA (US); Joaquin Garcia Fink, Mountain View, CA (US); L.W. Bryan Charnock, Harleysville, PA (US)

Correspondence Address: FISH & RICHARDSON, P.C., PO BOX 1022, MINNEAPOLIS, MN, 55402-1022, US

(21) Appl. No.: 10/738,620

(22) Filed: Dec. 16, 2003

(51) Int. Cl. G06F 3/00; G06F 15/16

(52) U.S. Cl. 715/758; 715/751; 715/759; 715/778; 715/741; 709/206

(57) ABSTRACT

Certain implementations of the invention are suitable for use in customer support systems where a service agent and a customer communicate via an interactive chat session. The computer system used by the service agent is capable of providing a graphical user interface (GUI) that displays at least a portion of the chat session in a reserved area. The service agent is able to view the messages of interactive chat session in a reserved area while viewing various task windows that ordinarily cover or replace the chat session window in the work area of the computer system's graphic user interface.

### TECHNICAL FIELD

This invention relates to computer systems, and more particularly to a user interface for computer systems.

### BACKGROUND

Conventional telephone call centers have provided opportunities for existing and potential customers to interact with customer service systems of businesses for various reasons. For example, a potential customer might contact a call center to request product or service information from a customer service agent of the business. In another example, the service agent of the business may contact existing or potential customers to offer them new or updated products and services from the business.

Interactive customer service systems use various forms of communication other than the traditional telephone call centers. The increasing usage of computer systems and networks provided existing and potential customers with yet another opportunity to interact with businesses. For example, a customer service system may use an interactive chat session between a service agent and a customer to handle customer questions, such as computer hardware/software support. In such situations, the service agent uses a computer workstation equipped with a desktop computer, a display monitor, and a keyboard to interact with the customer over a conventional online chat server. The service agent's computer workstation often includes a software program to assist the service agent in gathering information from the customer and in resolving the customer's questions.

Usually, the text of a chat session between the customer and the service agent is scrolled in a window of the service agent's computer workstation. The service agent reads the text of the customer's statements to gather information related to the customer's computer hardware/software support questions. In many cases, the software system on the service agent's workstation requires the service agent to open various other task windows in order to assist the customer. These task windows often cover the chat window and block the service agent's view of the ongoing chat session, thus forcing the service agent to repeatedly toggle between the chat session window and the task windows or menus while assisting the customer.

### SUMMARY

Certain implementations of the invention are suitable for use in customer support systems where a service agent and a potential or existing customer communicate via an interactive chat session. The computer system used by the service agent is capable of providing a graphical user interface (GUI) that displays at least a portion of the chat session in a reserved area.

In one implementation, a computer program product comprises executable instructions that, when executed, provide a graphical user interface (GUI) for displaying to a user at least a portion of a chat session between the user and an participating party. The GUI comprises a work area to display information relating to an interactive session between the user and the participating party. The information displayed in the work area is switchable between a chat session window and an alternative window. The GUI also comprises a reserved area to display at least a portion of the chat session. The reserved area is located in proximity to the work area such that the reserved area is noticeable to the user when the user is working in the work area. Also, the reserved area displays at least a portion of the chat session when the work area displays the alternative window.

Another implementation provides a method for displaying on a user's display device at least a portion of a chat session between the user and an participating party. In this implementation, the method includes displaying information in a work area of the display device. The information relates to an interactive session between the user and the participating party, and the information displayed in the work area is switchable between a chat session window and an alternative window. The method further comprises displaying at least a portion of a chat session in a reserved area of the display device. The reserved area is located in proximity to the work area such that the reserved area is noticeable to the user when the user is working in the work area. Also, the reserved area displays at least a portion of the chat session when the work area displays the alternative window.

Advantages of some implementations may be one or more of the following. In various scenarios, the chat session messages are prominently shown to the service agent in a reserved area of the computer system's graphic user interface. The service agent is able to constantly view the messages of interactive chat session while viewing various task windows that ordinarily cover or replace the chat session window in the work area of the computer system's graphic user interface. In this fashion, the agent can view certain information or enter search data and contemporaneously view the chat messages that are sent from the customer. Because the chat session is displayed to the service agent no matter what windows are displayed in the work area, there is no need for the service agent to toggle between the other windows and the chat session window. Also, there is a reduced likelihood of the service agent missing an important message from the customer in the chat session text due to another window obstructing the service agent's view of the chat session window.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a block diagram of a system that is capable of providing an interactive chat session, according to one implementation.

FIG. 2 illustrates a block diagram of a computer system that may be used in connection with the system of FIG. 1.

FIGS. 3A-C illustrate a first example of a graphical user interface that is capable of displaying at least a portion of an interactive chat session.

FIGS. 4A-E illustrate a second example of a graphical user interface that is capable of displaying at least a portion of an interactive chat session.

Like reference symbols in the various drawings indicate like elements.

### DETAILED DESCRIPTION

A service agent is able to continually view interactive chat messages while opening various task windows in the graphical user interface (GUI) of the agent's computer system. When any of these tasks windows cover or replace the chat session window in the work area of the computer system's GUI, the chat session messages are prominently shown to the service agent in a reserved area of the GUI. In this fashion, the agent can view information or enter search data in the task windows and still be able to view the chat messages that are sent from the customer. For example, the service agent may be engaged in a chat session with a customer having problems with the installation of a computer hardware product. The customer may send a chat message containing pertinent information in response to the service agent's questions, which causes the service agent to open a task window to further assist the customer in troubleshooting the particular problem. In such a scenario, the chat session is constantly displayed to the service agent in a reserved area of the computer system's GUI whenever the chat session window in the work area is covered or replaced by the task window or any other window.

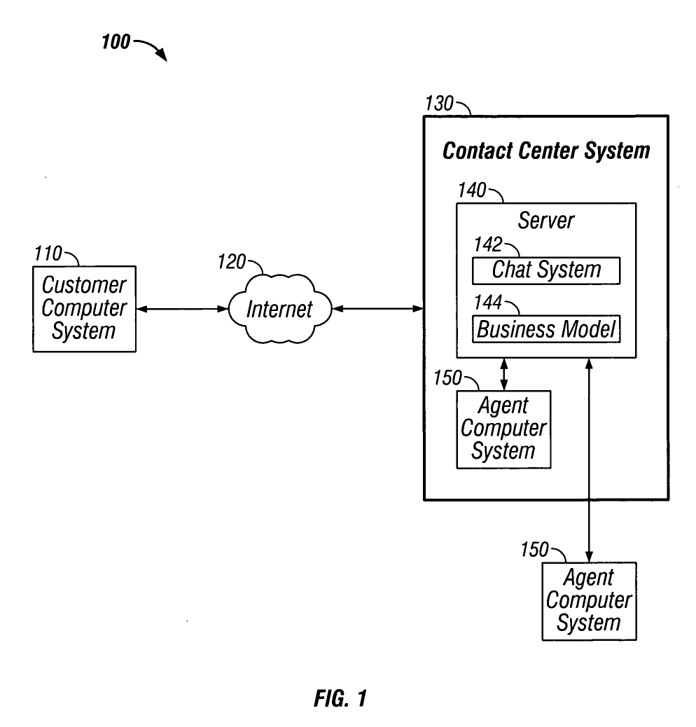

FIG. 1 shows one implementation of a system 100 that is capable of providing an interactive chat session between a plurality of parties. In this implementation, a customer uses a computer system 110 to connect via the internet 120 to a contact center system 130. The contact center system 130 includes a server 140 that maintains various software and/or hardware systems and one or more agent computer systems 150 that are connected to the server 140. In the implementation shown in FIG. 1, the contact center server 140 includes a chat system 142 that is capable of hosting a secured interactive chat session between the customer computer system 110 and the agent computer system 150. In addition, the server 140 may include a business model 144 that, when executed, is capable providing customer data, support information, alerts, or other business rules decisions to the agent's computer system 150.

In this implementation, the customer computer system 110 may be a conventional desktop computer system that is connectable to the internet or another network system. The customer computer system 110 may connect to the internet (or directly to the contact center system 130) using any network connections means. In addition, more than one customer computer system 110 may be connected to the contact center system 130 to participate in a single interactive chat session with an agent computer system 150 or in separate chat sessions with different agent computer systems 150.

Depending on the complexity of the contact center system 130, the contact center system 130 may include more than one server 140 that connects to agent computer systems 150. The agent computer systems 150 of the contact center system 130 may connect to the server 140 using any network connection means. Some agent computer systems 150 may be local to the server 140 and the contact center system 130 while other agent computer systems 150 may remotely connect to the server 140 and the contact center system 130.

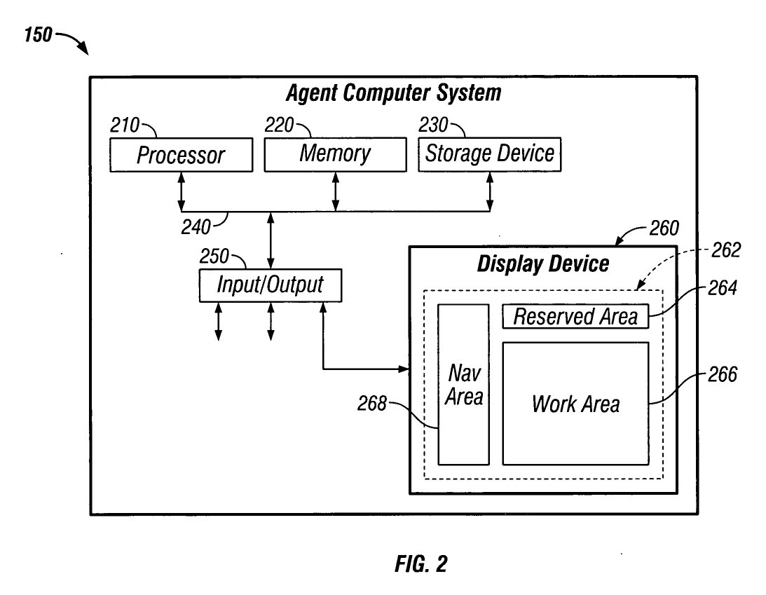

FIG. 2 shows a computer system that may be employed to display an interactive chat session. In this implementation, the agent computer system 150 includes a processor 210, computer memory 220, and a storage device 230 that are connected to a system bus 240. The computer system 150 also includes one or more input/output ports 250 that are connected to the system bus 240. A display device 260, such as a computer monitor or flat screen panel, is connected to the input/output port 250. Depending on the complexity of the computer system 150 and the contact center system 130, other devices may be included in the computer system 150 to efficiently enable the interactive chat session, such as user interface devices and network connection devices.

Still referring to FIG. 2, the display device 260 of the computer system 150 is capable of displaying a graphical user interface (GUI 262 when a computer program stored in the memory 220 or storage device 230 is properly executed. The GUI 262 may be displayed in a browser that is used to display various forms of information relating to the customer session. The browser may be any form of web-enabled browser, such as Internet Explorer, Netscape, Opera, Mozilla, and the like. The GUI 262 displayed to the user of the computer system 150 includes a reserved area 264 and a work area 266. Optionally, the GUI 262 may include a navigational area 268 so that the user may navigate through various windows displayed in the work area 266. The size, shape, and orientation of the browser, the reserved area 264, the work area 266, and the navigational area 268 may vary and are not limited to the implementation shown in FIG. 2.

The content shown in the work area 266 includes information relating to an interactive session between the service agent and the inquiring customer. For example, the work area 266 may be used to display a chat session window that includes the text of the chat session between the service agent and the customer. Other examples of information that may be displayed in the work area 266 include customer identity/account information, records of previous transactions with the customer, troubleshooting search criteria and solutions, and the like. The information displayed in the work area 266 may be displayed in various windows. For example, the user of the computer system 150 may select the chat session window to be displayed in the work area. At this point, the user is able to view the text of the interactive chat session. If the user selects another window for display in the work area, such as a window to verify the customer's identity/account information, the information displayed in the work area 266 may be switched from the chat session window to another window related to the customer's identity/account information.

To facilitate switching between information displayed in the work area 266, the GUI 262 may include a navigational area 268. In one implementation, the navigational area 268 includes a navigational HTML frame having selectable buttons. If the user of the computer system 150 selects one of the buttons, a particular window related to that button will be displayed in the work area 266. In this implementation, the user of the computer system 150 can efficiently switch between the information displayed in the work area 266 by selecting different buttons in the navigational area 268.

The reserved area 262 is located in proximity to the work area 266 such that it is noticeable to the user of the computer system 150 when the user is working in the work area 266. One function of the reserved area 264 is to display at least a portion of the chat session between the service agent and the customer whenever the chat session window in the work area 266 is covered or replaced by another window. For example, the service agent may view the chat session window in the work area 266 and subsequently select a button in the navigational area 268 to replace the chat session window in the work area 266 to show another window related to the customer identity/account information. In such a scenario, the chat session window in the work area 266 would be replaced by the customer identity/account information window, and the chat session messages would become displayed in the reserved area 264. Accordingly, there is no need for the service agent to toggle between the other windows and the chat session window to check for an update of the customer's chat session message. Moreover, there is a reduced likelihood of the service agent missing an important message from the customer in the chat session text due to another window obstructing the service agent's view of the chat session window in the work area 266.

In certain implementations, the reserved area 264 may be a navigational button for the user of the computer system 150. For example, the service agent may be viewing the customer identity/account information in the work area 266 when an important message from the customer appears in the chat session text displayed in the reserved area 264. The service agent may select (e.g., mouse click or move a cursor using a keyboard) the chat session text that is displayed in the reserved area 264, which acts as navigational button for the chat session window to appear in the work area 266.

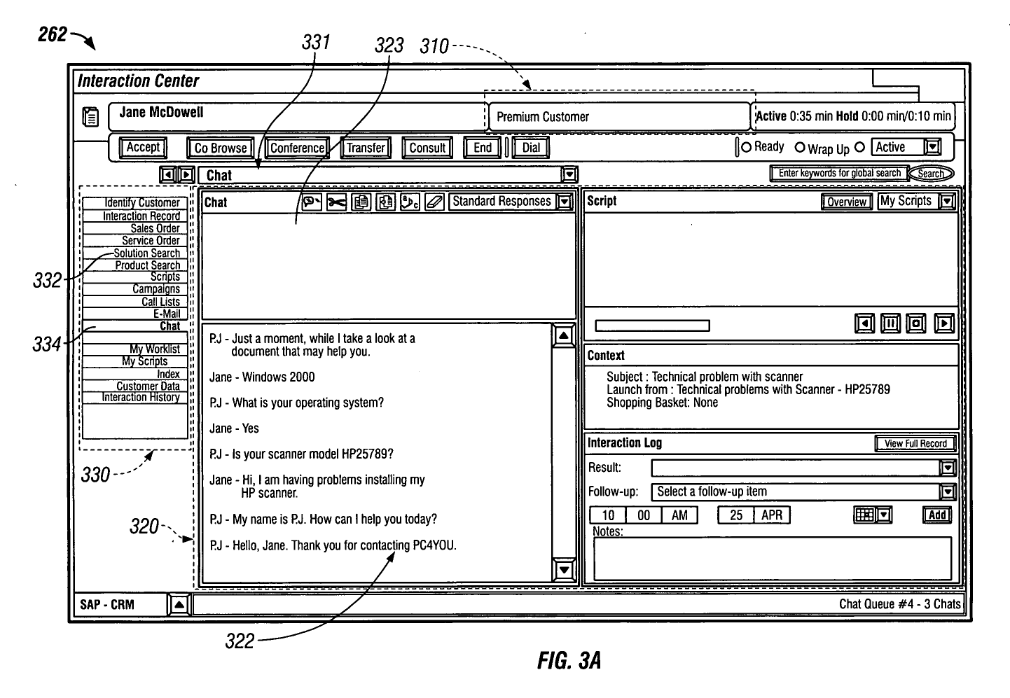

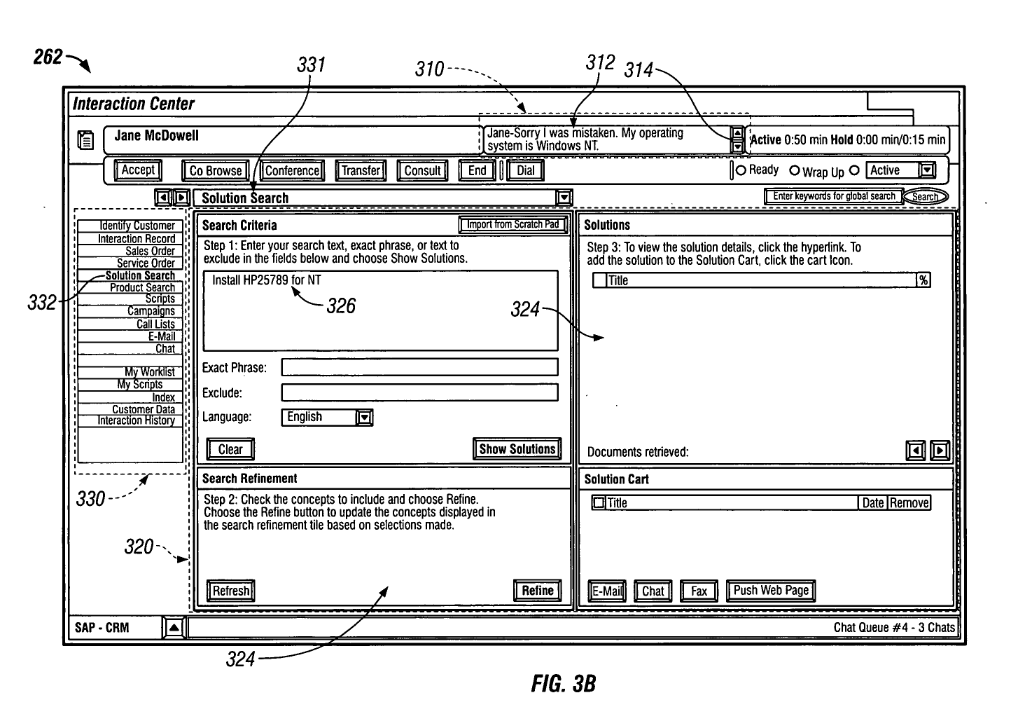

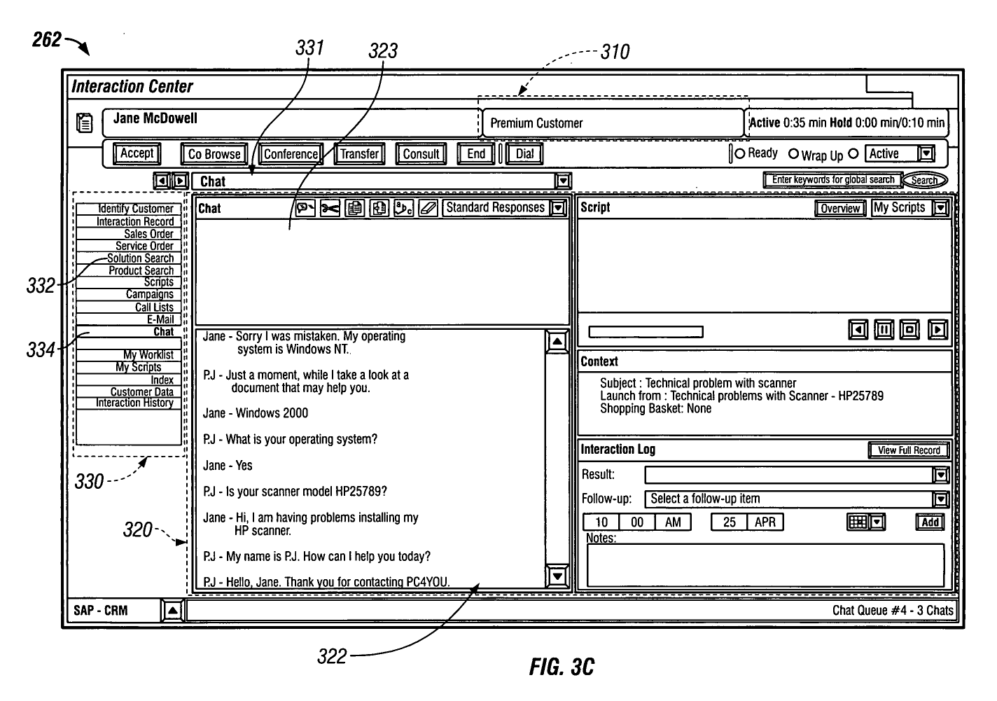

FIGS. 3A-C show one implementation of a GUI 262 that may be displayed using a computer system 150. This implementation shows only one possible example of the GUI 262, and it is understood that invention is not limited to this example illustrated in FIGS. 3A-C. Referring to FIG. 3A, the GUI 262 includes a reserved area 310, a work area 320, and a navigational area 330. A chat session window 322, which includes chat messages between a service agent (“P.J.”) and a customer (“Jane”), is displayed in the work area 320. The GUI 262 is displayed to P.J. as he uses an agent computer system 150 connected to the contact center system 130 (FIG. 1). P.J. is able to enter chat messages into the chat session by typing the text into the textual entry field 323 of the chat session window 322. While the chat session window 322 is displayed to the service agent, the reserved area 310 displays an alert to notify the service agent that the participating customer is a “Premium Customer.” Of course, other alerts or messages may be displayed in the reserved area 310 while the chat session window 322 is displayed in the work area 320.

Still referring to FIG. 3A, Jane is participating in the chat session with P.J. because Jane is having problems installing a computer hardware device. In his attempt to provide Jane with computer hardware support, P.J. asks Jane what operating system is running on her computer system (as shown in the messages in the chat session window 322). After learning that Jane is using WINDOWS 2000 operating system, P.J. proceeds to troubleshoot Jane's computer hardware problem.

Referring to FIG. 3B, P.J. selects a button 332 in the navigational area 330 to view a different window 324 (other than the chat session window 322) in the work area 320. Alternatively, P.J. could use a navigational pull-down menu 331 to select the another window for display in the work area 320. In this scenario, the window 324 displays information related to related to Jane's computer hardware problem based upon the information shared in the interactive chat session. In particular, the window 324 displays information related to troubleshooting search criteria and potential solutions to Jane's problem. As shown in FIG. 3B, the reserved area 310 displays a portion of the interactive chat session when the chat session window 322 (FIG. 3A) was covered or replaced by the other window 324 (FIG. 3B). Even though the chat session window 322 is not displayed in the work area 320, P.J. is able to view an important chat message 312 sent from Jane. Because P.J. learned that Jane was previously incorrect, and her operating system is actually WINDOWS NT, P.J. is able to enter the appropriate search information 326 into the solution search/troubleshooting window 324 without wasting time in a search for troubleshooting information related to WINDOWS 2000. If, for some reason, P.J. desires to read previous chat messages from the interactive chat session, he may use the scroll arrows 314 to cause other portions of the chat session to be displayed in the reserved area 310.

Referring to FIG. 3C, P.J. may enter a reply chat message to Jane by navigating to the chat session window 322. In this scenario, he may switch the information displayed in the work area 320 from the solution search/troubleshooting window 324 to the chat session window 322 by selecting the navigational button 334 in the navigational area 330 or by selecting the chat option from the navigational pull-down menu 331. Alternatively, P.J. may cause the chat session window 322 to be displayed in the work area 320 by selecting (e.g., mouse click) the chat message 312 (FIG. 3B) displayed in the reserved area 310. After the chat session window 322 is displayed in the work area 320, P.J. may send a new chat message by entering the text in the textual entry field 323 of the chat session window 322. As previously described, when the full chat session window 322 is displayed in the work area 320, the reserved area 310 may display other alerts or messages.

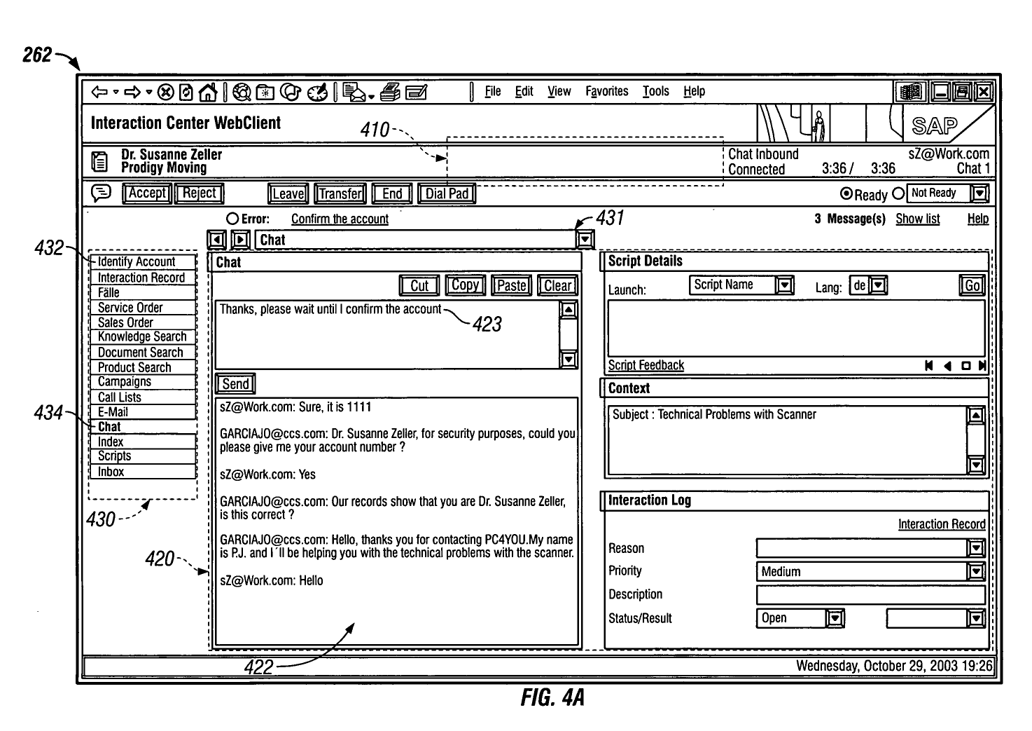

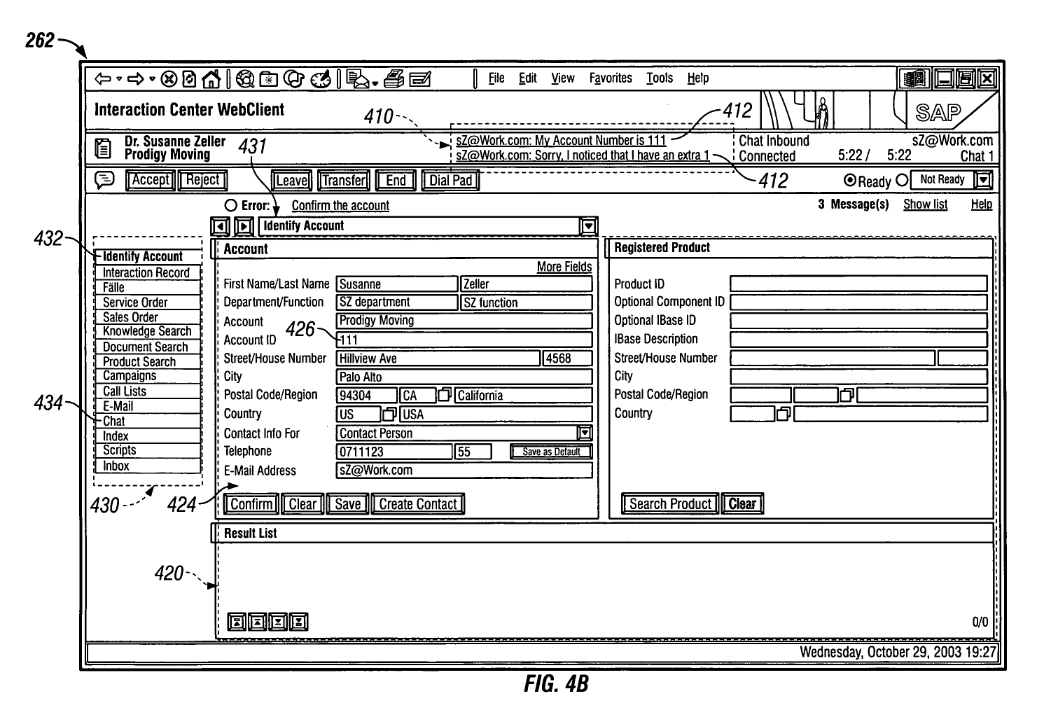

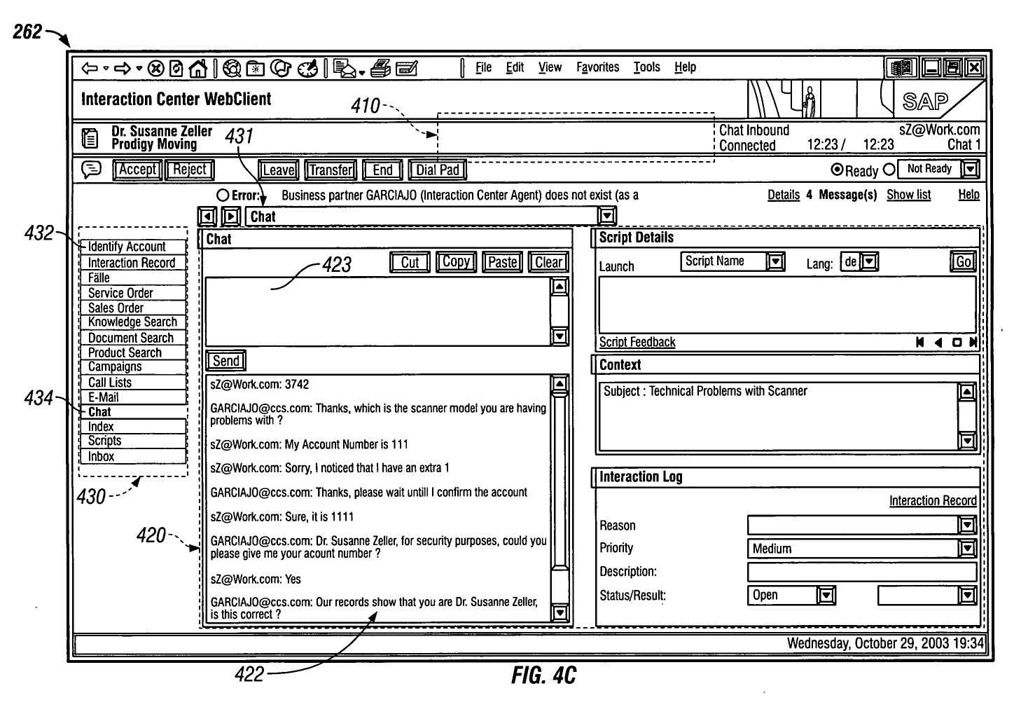

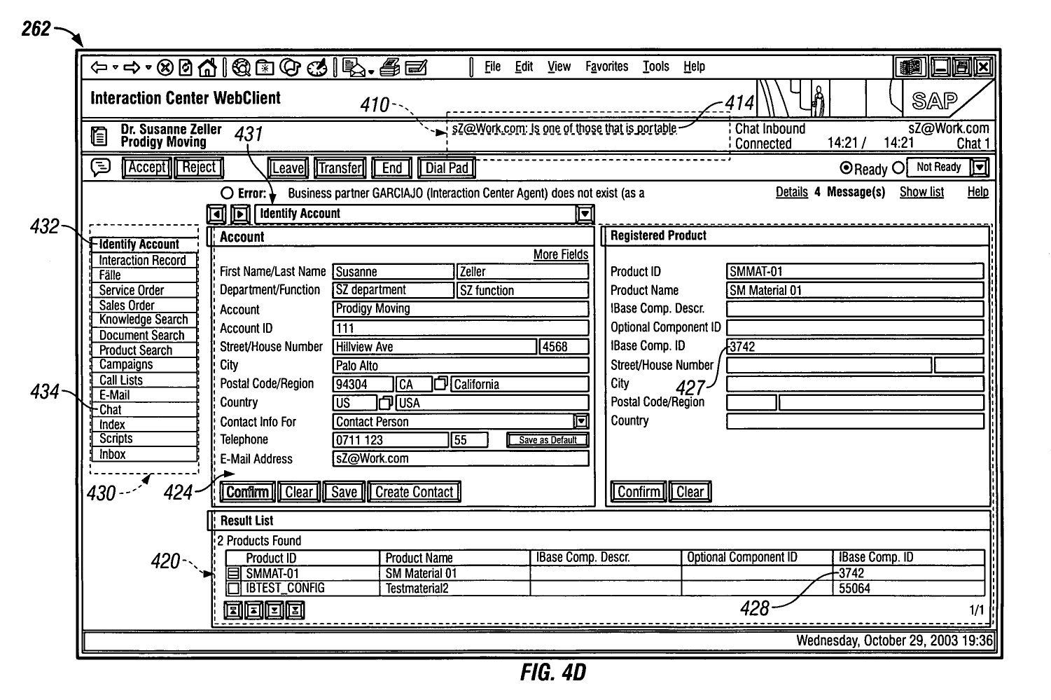

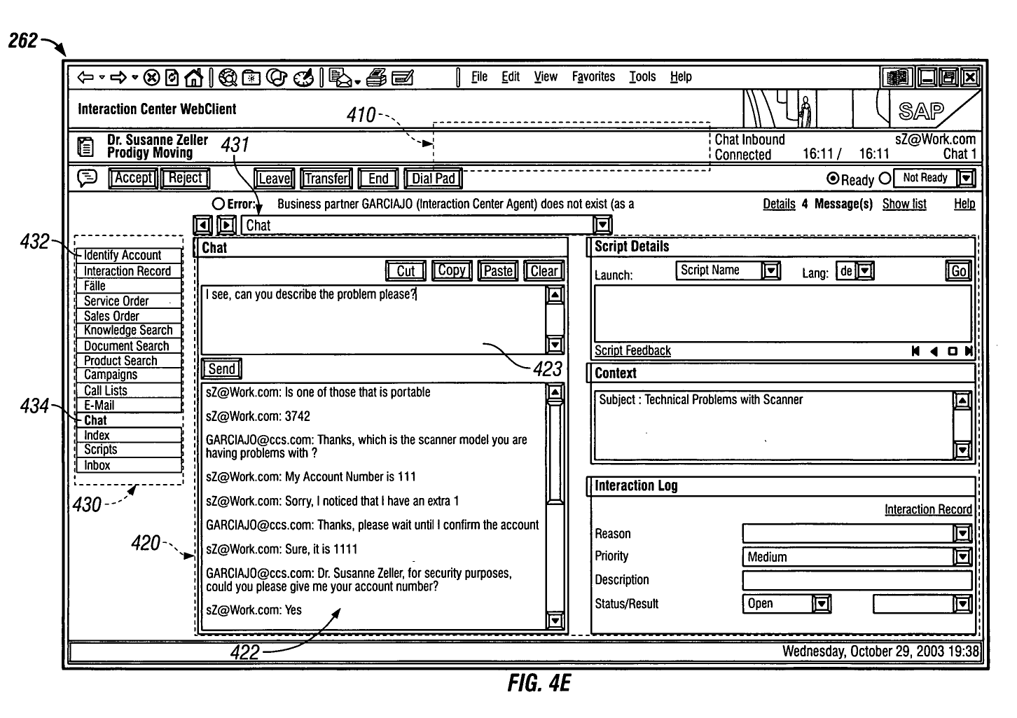

FIGS. 4A-E show yet another implementation of a GUI 262 that may be displayed using a computer system 150. This implementation shows only one possible example of the GUI 262, and it is understood that invention is not limited to this example illustrated in FIGS. 4A-E. Referring to FIG. 4A, the GUI 262 includes a reserved area 410, a work area 420, and a navigational area 430. A chat session window 422, which includes chat messages between a service agent (“garciojo@ccs.com”) and a customer (“sZ@Work.com”), is displayed in the work area 420. The GUI 262 is displayed to the service agent as he or she uses a computer system 150 connected to the contact center system 130 (FIG. 1). The service agent is able to enter chat messages into the chat session by typing the text into the textual entry field 423 of the chat session window 422. In this scenario, the customer is having technical problems with a computer hardware device (e.g., a scanner). As shown in the chat session window 422, the service agent requests the customer's account number during the initial stage of the interactive session. The customer informs the service agent that the account number is “1111.” Then the service agent selects a navigational button 432 in the navigational area 430 to switch the information displayed in the work area 430.

Referring to FIG. 4B, the service agent switches the information displayed in the work area 420 to an “Identify Account” task window 424. This task window displays information related to the customer's identity and other account information. When the information displayed in the work area 420 is switched from the chat session window 422 (FIG. 4A) to the task window 424 (FIG. 4B), the reserved area 410 displays a portion of chat session between the customer and the service agent. In this scenario, while the service agent attempts to verify the customer's account information, the customer sends an important chat message 412 that corrects the previously stated account number (e.g., informs the service agent that the correct account number is “111,” not “1111”). Because the service agent learned of the customer's correction, the service agent is able to enter the appropriate account number information 426 into the task window 424 to verify the customer's account without wasting time by attempting to verify the wrong account number. After the service agent enters the correct account number information 426, the service agent then returns to the chat session window 422 to request more information from the customer.

Referring to FIG. 4C, the service agent switches the information displayed in the work area 420 from the task window 424 to the chat session window 422 by selecting a navigational button 434 in the navigational area 430. Alternatively, the service agent may select the appropriate option from the navigational pull-down menu 431 to switch the information displayed in the work area 420. The service agent may request more information from the customer by entering a chat message in the textual entry field 423 of the chat session window 422. In this scenario, the service agent requests the model number of the computer hardware device that is troubling the customer, and the customer returns a chat message stating the proper model number (e.g., scanner model “3742”). At this point, the service agent desires to determine whether the previously described model number is covered under the customer's account.

Referring to FIG. 4D, the service agent switches the information displayed in the work area 420 from the chat session window 422 (FIG. 4C) to the task window 424 by selecting the navigational button 432 from the navigational area 430. The service agent then enters the model number stated by the customer (e.g., scanner model “3742”) into the proper field 427 of the task window 424. Even though the chat session window 422 has been covered or replaced by the task window 424 in the work area 420, the service agent is still able to view additional chat messages 414 in the reserved area 410. In this scenario, the chat message 414 sent by the customer was not necessarily important to the service agent when verifying the model number of the computer hardware device included in the customer's account. As previously described, however, there are instances when the customer's chat messages are important to the service agent's work in a task window displayed in the work area 420. In this instance, the service agent enters the model umber into the proper field 427 of the task window 424, and that particular model is shown in another field 428 to be covered under the customer's account. After verifying the customer's account and the proper model number, the service agent then returns to the chat session window 422 to request more information from the customer.

Referring to FIG. 4E, the service agent switches the information displayed in the work area 420 from the task window 424 to the chat session window 422 by selecting the navigational button 434 in the navigational area 430. Alternatively, the service agent may switch from the task window 424 to the chat session window 422 by selecting (e.g., mouse click) the chat message 414 (FIG. 4D) displayed in the reserved area. The service agent may request more information from the customer by entering a chat message in the textual entry field 423 of the chat session window 422. In this scenario, the service agent continues the effort to resolve the customer's computer hardware problems by asking the customer to describe the particular problem that is occurring. The interactive chat session may continue between the service agent and the customer while the service agent occasionally switches the information displayed in the work area 420 to alternative windows by selecting the various navigational buttons in the navigational area 430.

Certain implementations of the invention have been illustrated above, but it is understood that the scope of the invention is not limited to these implementations. For example, the invention is not limited to interactive chat sessions involving service agents. Rather, any user of a computer system that displays a chat session window may employ various implementations of the invention.

Likewise, implementations of the invention are not limited to chat sessions involving a potential or existing customer. Instead, any participating party may use a computer system to participate in a chat session with a user at the contact center system 130.

In another example, the invention is not limited to the system 100 disclosed in FIG. 1. Instead, the interactive chat session may be operated using various combinations of networks, computer systems, and chat servers. For instance, the chat system 142 for hosting an interactive chat session may be separate from the contact center server 140 and, in some implementations, separate from the contact server system 130 (e.g., located on a third-party server that is separate from the contact center system).

Furthermore, the computer system for displaying the previously described GUI is not limited to the implementation described in FIG. 2. Rather, the GUI may be displayed to a user by any computer system that is capable of executing instructions to display information on a display device.

A number of implementations of the invention have been described. Nevertheless, it will be understood that various modifications may be made without departing from the scope of the invention. Accordingly, other implementations are within the scope of the following claims.

1. A computer program product comprising executable instructions that, when executed, provide a graphical user interface (GUI) for displaying to a user at least a portion of a chat session between the user and a participating party, the GUI comprising:
a work area to display information relating to an interactive session between the user and the participating party, wherein the information displayed in the work area is switchable between a chat session window and an alternative window; and
a reserved area to display at least a portion of the chat session, the reserved area being located in proximity to the work area such that the reserved area is noticeable to the user when the user is working in the work area, and wherein the reserved area displays the at least a portion of the chat session when the work area displays the alternative window.

2. The computer program product of claim 1, wherein the alternative window covers at least a portion of the chat session window when the alternative window is displayed in the working area.

3. The computer program product of claim 1, further comprising a navigational area located in proximity to the work area.

4. The computer program product of claim 3, wherein the navigational area includes buttons that are selectable by the user to switch the information displayed in the work area.

5. The computer program product of claim 1, wherein the alternative window displayed in the work area is a task window for identifying the participating party or the participating party's account.

6. The computer program product of claim 1, wherein the alternative window displayed in the work area is a task window for troubleshooting a problem with a product or service.

7. The computer program product of claim 1, wherein the participating party is an existing or potential customer inquiring about product or service information.

8. The computer program product of claim 1, wherein the user is a service agent for providing product or service information to the participating party.

9. The computer program product of claim 8, wherein the user is a service agent for providing computer hardware or software support information to the participating party.

10. A method for displaying on a user's display device at least a portion of a chat session between the user and a participating party, the method comprising:
displaying information in a work area of the display device, the information relating to an interactive session between the user and the participating party, wherein the information displayed in the work area is switchable between a chat session window and an alternative window; and
displaying at least a portion of a chat session in a reserved area of the display device, the reserved area being located in proximity to the work area such that the reserved area is noticeable to the user when the user is working in the work area, and wherein the reserved area displays at least a portion of the chat session when the work area displays the alternative window.

11. The method of claim 10, wherein the alternative window covers at least a portion of the chat session window when the alternative window is displayed in the working area.

12. The method of claim 10, further comprising displaying a navigational area located in proximity to the work area.

13. The method of claim 12, wherein the navigational area includes buttons that are selectable by the user to switch the information displayed in the work area.

14. The method of claim 10, wherein the alternative window displayed in the work area is a task window for identifying the participating party or the participating party's account.

15. The method of claim 10, wherein the alternative window displayed in the work area is a task window for troubleshooting a problem with a product or service.

16. The method of claim 10, wherein the participating party is an existing or potential customer inquiring about product or service information.

17. The method of claim 10, wherein the user is a service agent for providing product or service information to the participating party.

18. The method of claim 17, wherein the user is a service agent for providing computer hardware or software support information to the participating party.

19. A computer program product comprising executable instructions that, when executed, perform a method to display on a user's display device at least a portion of a chat session between the user and a participating party, the method comprising:
displaying information in a work area of the display device, the information relating to an interactive session between the user and the participating party, wherein the information displayed in the work area is switchable between a chat session window and an alternative window; and
displaying at least a portion of a chat session in a reserved area of the display device, the reserved area being located in proximity to the work area such that the reserved area is noticeable to the user when the user is working in the work area, and wherein the reserved area displays at least a portion of the chat session when the work area displays the alternative window.
